(19) United States
(12) Patent Application Publication
(10) Pub. No.: US 2008/0114733 A1
(43) Pub. Date: May 15, 2008

(54) USER-STRUCTURED DATA TABLE INDEXING

(75) Inventors: Dustin G. Friesenhahn, Redmond, WA (US); Naresh Kannan, Seattle, WA (US); Robert G. Lefferts, Redmond, WA (US); W. Bruce Jones, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/759,503

(22) Filed: Jun. 7, 2007

Related U.S. Application Data
(60) Provisional application No. 60/859,165, filed on Nov. 14, 2006.

(51) Int. Cl. G06F 17/30

(52) U.S. Cl. 707/3; 707/E17.014

(57) ABSTRACT

User-structured data tables can be queried more efficiently by storing a copy of the important data from a user-structured data base table in one or more special indexes. A special index normally comprises Name Value Pairs (NVP) that can be used to efficiently query the important data by using the database indexes. Efficient querying can be accomplished by creating a separate table for a user-structured table, indexing the separate table using NVPs; and creating multiple tables in a collation order in order to search data that is sorted in accordance with user conventions in various locales.

### RELATED APPLICATION

This utility patent application claims the benefit under 35 United States Code § 119(e) of U.S. Provisional Patent Application No. 60/859,165 filed on Nov. 14, 2006, which is hereby incorporated by reference in its entirety.

### BACKGROUND

Information is stored on various data systems for convenient access at a later time. However, the information is often stored in differing formats, even when similar systems are used. Also, many databases are user-created, which even further compounds the diversity of storage formats. Often, many types of data are all stored in a relatively large, but sparsely populated, database table. Such data storage can be relatively difficult to query because, for example, multiple tables can have shared or disparate column headings and can have list items that are often left empty. The various approaches often complicate the process of searching for desired data that is stored amongst different types of data.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Data can be stored and searched for in information systems using a list for representing the stored data. A list is typically a collection of items (e.g., rows in a table) which have properties (e.g., columns in a table). Some list examples include a set of personal contacts with properties (such as name, address, company), a set of parts with properties (such as cost or size), and a set of documents with properties (such as last modified time or author).

Database tables are commonly used for storing such data. For some applications, it is often necessary to create a single wide database table that is quite often only sparsely populated to store information (rather than by using separate tables to store the information). This is especially useful for generating large numbers of lists that can be defined because many database servers typically support many items in a table, rather than many different tables having few items. Such tables are often referred to as being a sparse database design, because many of the cells in the database are not populated.

A separate table can be created for storing a copy of the important data from a sparse data base table. The separate table comprises Name Value Pairs (NVP) that can be used to efficiently query the important data by using the database indices. Efficient querying can be accomplished by creating a separate table for a sparse table, indexing the separate table using NVPs; and creating multiple tables in a collation order in order to search data that is sorted in accordance with user conventions in various locales.

These and other features and advantages will be apparent from a reading of the following detailed description and a review of the associated drawings. It is to be understood that both the foregoing general description and the following detailed description are explanatory only and are not restrictive. Among other things, the various embodiments described herein may be embodied as methods, devices, or a combination thereof. Likewise, the various embodiments may take the form of an entirely hardware embodiment, an entirely software embodiment or an embodiment combining software and hardware aspects. The disclosure herein is, therefore, not to be taken in a limiting sense.

### BRIEF DESCRIPTION OF THE DRAWINGS

FIG. 1 is an illustration of an example operating environment and system for querying across disparate schemas.

FIG. 2 is an illustration of two paradigms for storing data.

FIG. 3 is an illustration of overloading columns within a sparse data table design.

FIG. 4 is an illustration of a compacted sparse data table design.

FIG. 5 is an illustration of an example Name Value Pair table for a sparse data table.

### DETAILED DESCRIPTION

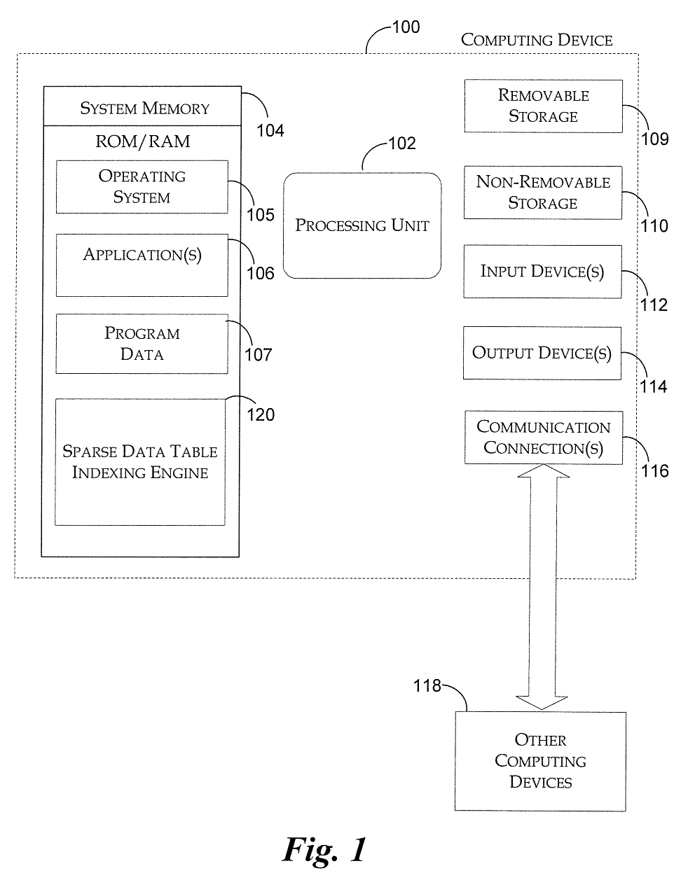

As briefly described above, embodiments are directed to dynamic computation of identity-based attributes. With reference to FIG. 1, one example system for expansion of list items for previewing includes a computing device, such as computing device 100. Computing device 100 may be configured as a client, a server, a mobile device, or any other computing device that interacts with data in a network based collaboration system. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107 in which rendering engine 120, can be implemented in conjunction with processing 102, for example.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In accordance with the discussion above, computing device 100, system memory 104, processor 102, and related peripherals can be used to implement sparse data table indexing engine 120. Sparse data table indexing 120 in an embodiment can be used to efficiently query data within sparse data tables (described below).

People use data base programs for storing data so that the data can be conveniently searched and retrieved at a later time. However, many such programs have been developed that require special training to use. Accordingly, easy-to-use data base programs have been written that use relatively unstructured data that is not stored in a uniform manner, such as in a sparse data base design. For example, a sparse data base typically stores list items as cells in a list that is arranged in rows and columns.

For example, the list items are usually grouped in columns (which each column is used to specify a type of an element, such as a “name,” “address,” or “phone number”) and rows (where each row is used to identify a person or thing, such as personal data, a mail list, job status, and the like). Multiple tables can have shared or disparate column headings, and can have list items that are often left empty.

However, such easy-to-use designs can be difficult to efficiently query by value, difficult to efficiently query across multiple sets of data (lists), and to efficiently query by value in a database design in accordance with user's conventions in various locales.

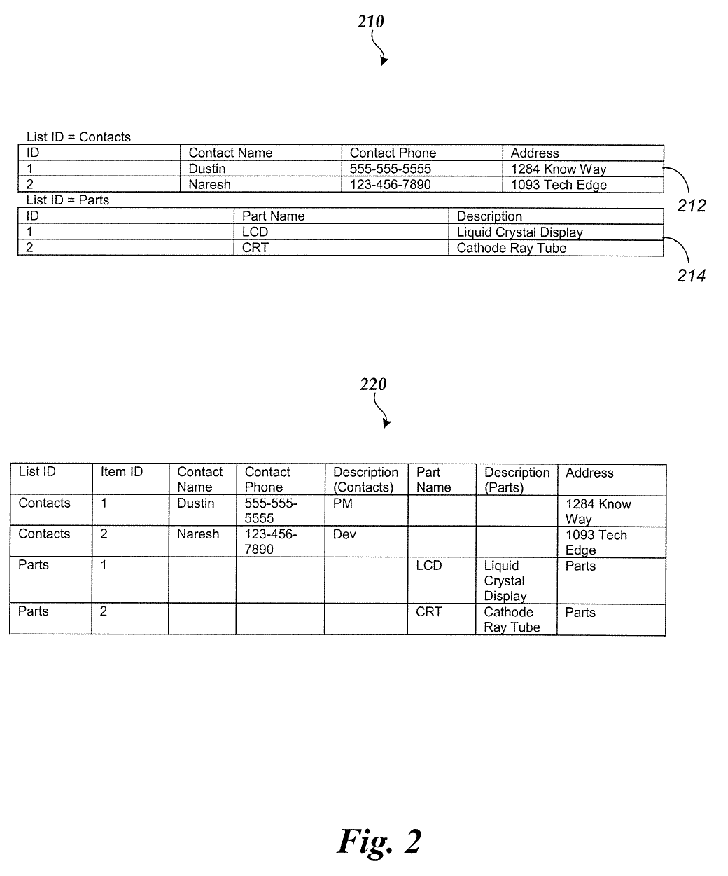

FIG. 2 is an illustration of two paradigms for storing data. Design 210 is a design that uses multiple tables (whereas design 220 is a sparse data table design). For example, design 210 comprises tables 212 and 214. Table 212 has a list identifier of “Contacts.” As illustrated, table 212 comprises four columns: an identifier (for identifying a contact item, which does not necessarily have to be unique), a contact name (such as a person's name), a contact phone number, and a physical address. The table is populated with two items, having identifiers of “1” and “2.” (It can be seen that the data need not be stored literally within the confines of a cell address: for example, levels of indirection can be used, such as pointers to where the data is actually stored.)

Table 214 has a list identifier of “Parts.” As illustrated, table 214 comprises three columns: an identifier (for identifying a parts item, which does not necessarily have to be unique), a part name, and a description. The table is populated with two items, having identifiers of “1” and “2.”

Design 220 is a sparse data table design. For example, design 220 comprises eight columns: a list identifier (for identifying a list), an item identifier (which does not necessarily have to be unique), a contact name (such as a person's name), a contact phone number, a parts description, a part name, a parts description and a physical address.

The table is populated with four items, two each from tables 212 and 214. For example, items “1” and “2” from table 212 have been included, as well as items “1” and “2” from table 214 have been included. It can be seen that various cells remain unpopulated, which is a characteristic of sparse data table designs. Moreover, it can be seen that as more unrelated (or partially related) data is added, the unpopulated cells occur even more frequently (which is often due to lack of commonality in column types).

In some cases, the actual schema of the data to be stored can be user-defined and/or dynamically instantiated in the application. Thus, the initial table design might be fixed, but the actual values stored in each column could vary based on a user's scenario. A user can use Name Values Pairs (NVPs) for specifying what type of data from the lists can be used to create indexes.

For example, which columns hold which data in a sparse data table design is typically determined by the list (within the overall table) to which the data belongs. One row (from a first list) might use “Integer1” for the size of the item, and another row (from a second list) might also use “Integer1” for the cost of an item. The schema that is being used would be typically determined by consulting which particular list hosts a particular item.

In some cases, the actual schema of the data to be stored can be user-defined and/or dynamically instantiated in the application. Thus, the initial table design might be fixed, but the actual values stored in each column could vary based on a user's scenario. A user can use Name Values Pairs (NVPs) for specifying what type of data from the lists can be used to create indexes.

In some cases, the actual schema of the data to be stored might be user defined and dynamic in the application. The initial table design would be fixed, but the actual values stored in each column might vary based on the user scenario.

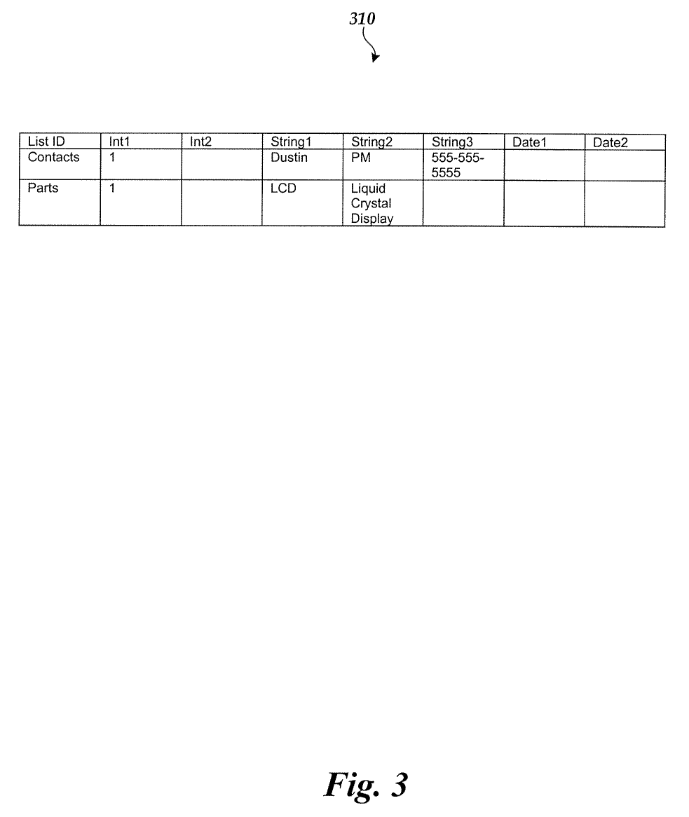

FIG. 3 is an illustration of overloading columns within a sparse data table design. For example, design 310 comprises eight columns: a list identifier (for identifying a list), Int1 (a first integer), Int2 (a second integer), String1 (a first string), String2 (a second string), String3 (a third string), Date1 (having a “date” data format), and Date2.

Data from different lists (such as from tables 112 and 114) can be stored in a more compact form by sharing columns having compatible data types (such as integer, string, date, and the like). For example, a column having a data type of integer can be used to hold a list number. In similar fashion, a column having a data type of string can be used to hold string data such as contact name, part name, job description, part description, phone number, address and the like.

Trying to query across this data can be difficult since no one column contains data that is aligned to a schema of a particular list. There may also be many lists in the table that are not relevant to the query, or that contain no items that are relevant to the query. Also, data is often stored in a de-normalized fashion, such that a logical “item” has data spread out in different locations (in separate tables, for example). Two schemas may define this separation in different ways, which require queries of different forms. Such data can be efficiently queried by first limiting (or otherwise qualifying) the total number of lists queried, and then aligning the data being queried.

Sparse database designs can be scalable to support an infrastructure for users to store various lists, and allow the users to customize the properties on each list (such as name, phone, address, and the like. After a sparse database design has been populated with data, users often want to define rich queries over the data.

An index can be added to a database table to make queries more efficient. However, simply indexing all columns is not usually sufficient because most database servers do not perform efficiently with relatively large amounts of indexes. The software vendor cannot normally optimize the indices because the vendor does not usually have beforehand knowledge of which properties are to be queried. The vendor does not usually have beforehand knowledge of which properties are to be queried because the properties are defined by users that subsequently purchase the software.

Further complicating the design is that one column in the table could actually store data from different lists, so a single column does not always contain related data (e.g., data from the same list). Having columns with unrelated data usually makes it difficult to use the typical indexing mechanisms that conventional databases provide.

Querying is difficult because indexing each additional column can cause substantial decreases in performance. Moreover, because properties (e.g., columns) are user defined, the system doesn't know beforehand which properties would be important for optimizing queries. Because all lists typically share the same table, a column does not always contain the same property for all rows.

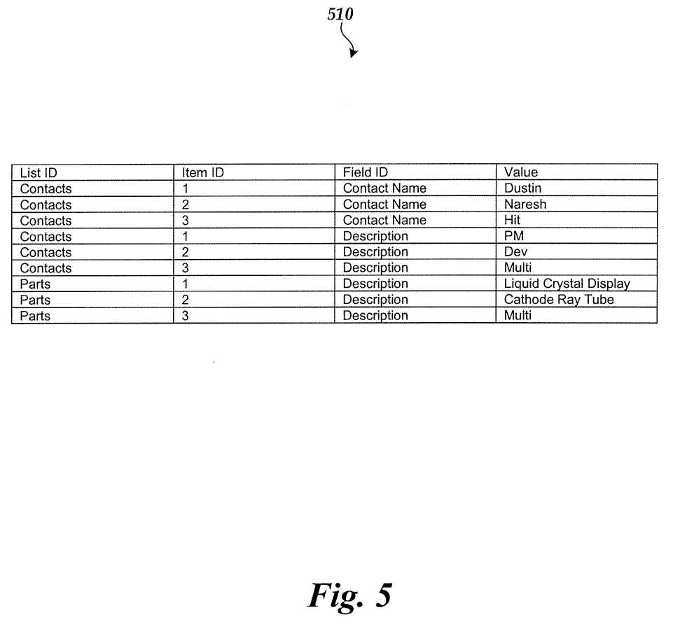

Creating a separate fixed table allows using a database index (based on user definitions) over a consistent set of properties. Although there is an added cost of keeping the table up-to-date with a copy of the data, the index allows the benefit of “rich” queries (such as described below with respect to FIG. 5). The fixed table can then be populated with the data that the end user would want to query.

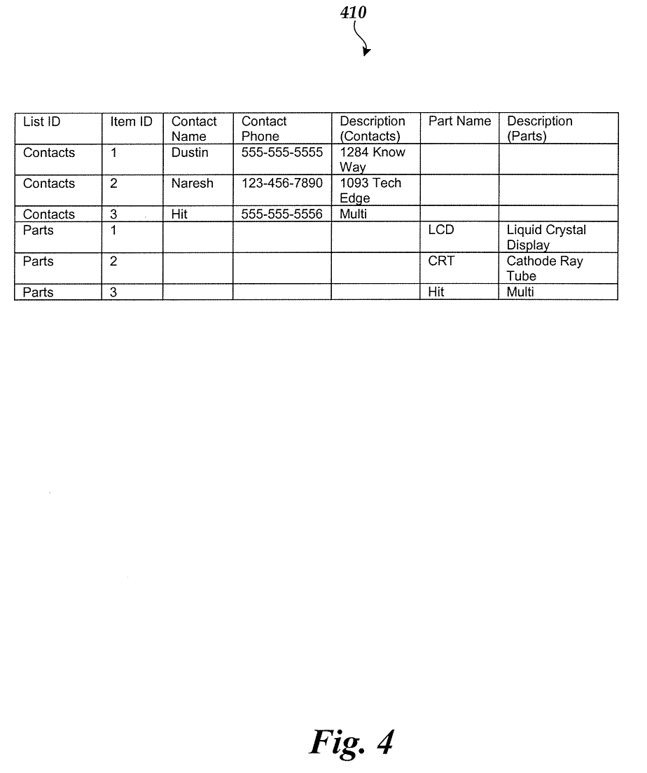

FIG. 4 is an illustration of a compacted sparse data table design. As shown in the List ID column of table 410, two example lists of data are stored (Contacts and Parts). As also shown, each column in the table can have different characteristics for storing data. For example, the Contacts list has properties of Contact Name, Contact Phone, and Description (of Contacts) and the Parts list has properties of Part Name and Description (of Parts).

FIG. 5 is an illustration of an example Name Value Pair table for a sparse data table. In table 510, querying is enabled over the following properties: Contact Name, Contact Description, and Part Description. The NVP (name value pair) table typically contains the following values: the list ID (which is typically the list the item belongs to), an item ID (which is typically a way to uniquely identify a specific item in the list), a field ID (which is typically the field that was indexed), and a value (which is typically the value of the field).

Some of the lists that are stored in the same sparse data table could have the same property type (such as “Description” in the example table 410). Even if same property type is stored in separate columns in the sparse table, the same field identifier can be used as an index to find values associated with the field identifier. Thus a search using a field identifier can retrieve data from different lists when, for example, two different lists in a sparse data table share common properties.

Table 510 provides data in a consistent form, which allows customization of the way the user-supplied data and properties is indexed. The way the data is indexed can be customized in accordance with a particular application. For example, the application can use the indices of the NVP table to perform fast queries in one list, fast queries across lists, and to efficiently locate items in the NVP table.

When performing fast queries in one list, the List ID, Field ID, Value, and Item ID can be used as indices to search rows (index entry groups) of the NVP table. Thus searches using these keys can efficiently find a set of items which have a particular value. For example, a search for finding the Item ID using the keys “List ID=Contacts, Field ID=Contact Name, Value=Dustin” would result in the return of the value of “1” for the Item ID. The Item ID can be used to efficiently retrieve other data associated with the key set by, for example, searching the sparse data table for the Item ID associated with the specified contact list.

To perform fast queries across lists, the Field ID and Value can be used as an index to search the NVP table. The index can be queried for items with a particular value across multiple different lists. For example, a search for finding the Item ID and List ID using the key “Description=Multi” would return the result of “Contacts, 3” and “Parts, 3,” which are the third entries of the Contacts list and the Parts list, respectively.

To efficiently locate items in the NVP, the list ID and Item ID can be used as an index. Thus rows in the NVP table that would need to be updated can be easily found when an item is changed in the sparse data table (which can be used to keep the NVP synchronized with the sparse table). For example, a search for finding the rows where “Item ID=1” and “List ID=Contacts” would return the results of “Contact Name, Dustin,” and “Description, PM.”

An additional problematic situation can occur when supporting multiple collations (sort orders). For example, most database servers have the inability to create an index on data that does not share the same kind of collation. The big sparse data table can be used to store data from multiple lists, but it is also possible that the data being stored by users is in different languages or is from different locales where grammatical conventions differ. Accordingly, the way in which the data is sorted could differ in response to, for example, a locale (such as a geographical location).

To create a database index that can work across different collations, multiple copies of the NVP table can be created such that each created NVP table is associated with a different collation. For example, for a sparse data table containing French and Latin values (which may have differing alphabets), a French NVP table and a Latin NVP table would be created. In a similar fashion, a table having (for example) contact information in English and Japanese could have an English NVP table and a Japanese table for allowing data from multiple collations to be presented.

It can be seen that NVP tables tend to be even more beneficial when querying larger sparse data tables. When querying fairly small sparse data tables (such as under 2000 entries, for example), the performance cost of maintaining NVP tables might be greater than the savings provided by using the NVP tables. An efficiency threshold can be set such that when a sparse data table grows above a certain threshold, sparse data table indexing using NVP tables can be enabled. The NVP indexing feature could also be turned on in response to user queries of specific types that would benefit from the NVP indexing feature.

The above specification, examples and data provide a complete description of the manufacture and use of embodiments of the invention. Since many embodiments of the invention can be made without departing from the spirit and scope of the invention, the invention resides in the claims hereinafter appended.

We claim:

1. A computer-implemented method for searching for data in user-structured tables, comprising:
receiving user-selected properties for storing lists of data in a user-structured data table, wherein the user-selected properties comprise a list identifier property and a field identifier property for identifying at least one data category that is associated with a list;
storing data values from users in the user-structured data table wherein each data value has an associated field identifier, associated list identifier, and associated item identifier such that each data value is associated with an item identifier that is unique for the list identified by the list identifier; and
creating a first indexing table comprising data values from the user-structured data table, wherein each data value has the associated item identifier from the user-structured data table, the associated field identifier from the user-structured data table, and the associated list identifier from the user-structured data table.

2. The method of claim 1, further comprising sorting the first indexing table using a first collation order.

3. The method of claim 2, further comprising creating a second index table using a second collation order that is different from the first collation order.

4. The method of claim 3, wherein the first and second collation orders are associated with different locales.

5. The method of claim 3, wherein the second index table comprises words in a language that is different from the words comprised be the first index table.

6. The method of claim 1, further comprising receiving a query for retrieving data from the user-structured data table, using a key from the received query to query the first index table and obtain a return value, and using the return value to query the user-structured data table.

7. The method of claim 6, wherein the user-structured data table is queried directly using the received query when the number of rows in the user-structured data table is less than an efficiency threshold.

8. The method of claim 6, wherein the received query comprises a list identifier, a field identifier, a data value, and a return value for an item identifier.

9. The method of claim 6, wherein the received query comprises a field identifier, a data value, a return valued for a list identifier, and a return value for an item identifier.

10. The method of claim 1, further comprising changing a data value in the first indexing table in response to a user command modifying an associated data value stored in the user-structured data table.

11. The method of claim 1, further comprising changing a field value in the first indexing table in response to a user command modifying an associated field identifier stored in the user-structured data table.

12. An information retrieval and storage system, comprising:
a first data register comprising rows and columns, wherein the columns are indexed by using user-selected properties, wherein the user-selected properties comprise a list identifier and a field identifier for identifying at least one data category that is associated with a list, and wherein each row comprises a list identifier, a field for storing data values for the user-selected properties, and an item identifier that is unique for the identified list; and
a second data register comprising index entries, wherein each index entry comprises a data value from the first data register and the item identifier, the field identifier, and the list identifier that are associated with the data value from the first data register; and
a query engine that is configured to receive a query for locating data in the first data register by using a term in the query to locate an index entry in the second data register and using the located index entry to locate data in the first data register.

13. The system of claim 12, wherein the index entries in the second data register are arranged according to a first collation order.

14. The system of claim 13, further comprising a third data register that comprises index entries, wherein each index entry comprises a data value from the first data register and the item identifier, the field identifier, and the list identifier that are associated with the data value from the first data register, wherein the index entries in the third data register are arranged according to a second collation order.

15. The system of claim 14, wherein the index entries of the second data register are in a language that is different from the index entries of the third data register.

16. The system of claim 12, wherein the index entries in the second data register are changed in response to a change in data values of the first data register.

17. The system of claim 12, wherein the query engine is further configured to query the first data register directly using the received query when the number of rows in the first data register is less than an efficiency threshold.

18. A tangible computer-readable medium comprising instructions for searching for data in user-structured tables, comprising:
receiving user-selected properties for storing lists of data in a user-structured data table, wherein the user-selected properties comprise a list identifier property and a field identifier property for identifying at least one data category that is associated with a list;
storing data values from users in the user-structured data table wherein each data value has an associated field identifier, associated list identifier, and associated item identifier such that each data value is associated with an item identifier that is unique for the list identified by the list identifier;
creating a first indexing table comprising data values from the user-structured data table, wherein each data value has the associated item identifier from the user-structured data table, the associated field identifier from the user-structured data table, and the associated list identifier from the user-structured data table;
sorting the first indexing table using a first collation order; and
receiving a user query for retrieving data from the user-structured data table by using a key from the received query to query the first index table to obtain a return value, and using the return value to query the user-structured data table.

19. The tangible medium of claim 18, wherein the collation order comprising sorting the data values first and the list identifiers last.

20. The tangible medium of claim 18, further comprising changing a data value in the first indexing table in response to a user command modifying an associated data value stored in the user-structured data table.
